(19) United States
(12) Patent Application Publication
(10) Pub. No.: US 2023/0294686 A1
(43) Pub. Date: Sep. 21, 2023

(54) DRIVING SUPPORT DEVICE, VEHICLE, DRIVING SUPPORT METHOD, AND STORAGE MEDIUM

(71) Applicant: HONDA MOTOR CO., LTD., Tokyo (JP)

(72) Inventors: Masayuki NAKATSUKA, Wako-shi (JP); Shinya MARUO, Wako-shi (JP); Takeshi TAMAKI, Wako-shi (JP); Chihiro OGURO, Wako-shi (JP); Junji MORIGUCHI, Wako-shi (JP)

(21) Appl. No.: 18/111,870

(22) Filed: Feb. 20, 2023

(30) Foreign Application Priority Data
Mar. 15, 2022 (JP) 2022-040715

(51) Int. Cl. B60W 30/095; B60W 40/06; B60W 30/18

(52) U.S. Cl. CPC B60W 30/0956; B60W 30/18163; B60W 40/06; B60W 2552/00; B60W 2556/40

(57) ABSTRACT

The present invention provides a driving support device that performs driving support of a vehicle, comprising: a detector configured to detect a surrounding situation of the vehicle; a control unit configured to operate the driving support of the vehicle in a case where a positional relationship between a detected target by the detector and the vehicle satisfies an operating condition; a specifying unit configured to specify a traveling course of the vehicle; and a determination unit configured to determine whether there is an intersecting structure that three-dimensionally intersects a traveling road of the vehicle in the specified traveling course, wherein in a case where the determination unit determines that there is the intersecting structure in the traveling course, the control unit changes the operating condition such that operation of the driving support with respect to the detected target is restricted.

### CROSS-REFERENCE TO RELATED APPLICATION(S)

This application claims priority to and the benefit of Japanese Patent Application No. 2022-040715 filed on Mar. 15, 2022, the entire disclosure of which is incorporated herein by reference.

### BACKGROUND OF THE INVENTION

### Field of the Invention

The present invention relates to a technique of controlling a vehicle.

### Description of the Related Art

Japanese Patent Laid-Open No. 2017-515227 discloses a vehicle front collision warning system. The forward collision warning system does not output a warning when a target object detected by a forward vehicle sensor matches a target object accumulated in the database of false alarms at a position of a vehicle detected by a global positioning system, and outputs a warning when the target object does not match the target object accumulated in the database.

In a traveling road of the vehicle, there is an intersecting structure that three-dimensionally intersects the traveling road, such as an overpass (over-bridge, pedestrian bridge) or a railway (for example, a monorail). There is a very low possibility that the vehicle will collide with such an intersecting structure, but depending on a shape (gradient or the like) of the traveling road for passing below the intersecting structure, the intersecting structure may be detected by a sensor of the vehicle, and driving support such as an alarm may malfunction.

### SUMMARY OF THE INVENTION

The present invention provides, for example, a technology capable of improving safety of a vehicle by appropriately operating driving support of the vehicle.

According to one aspect of the present invention, there is provided a driving support device that performs driving support of a vehicle, the driving support device comprising: a detector configured to detect a surrounding situation of the vehicle; a control unit configured to operate the driving support of the vehicle in a case where a positional relationship between a target detected by the detector and the vehicle satisfies an operating condition; a specifying unit configured to specify a traveling course of the vehicle; and a determination unit configured to determine whether there is an intersecting structure that three-dimensionally intersects a traveling road of the vehicle in the traveling course specified by the specifying unit, wherein in a case where the determination unit determines that there is the intersecting structure in the traveling course, the control unit changes the operating condition such that operation of the driving support with respect to the target detected by the detector is restricted.

Further features of the present invention will become apparent from the following description of exemplary embodiments with reference to the attached drawings.

### BRIEF DESCRIPTION OF THE DRAWINGS

FIG. 1 is a block diagram of a vehicle and a control device thereof;

FIG. 2 is a diagram illustrating driving support executed in each mode;

FIG. 3 is a block diagram illustrating a configuration example of a driving support device;

FIG. 4 is a diagram illustrating an example in which a railroad of a monorail as an intersecting structure three-dimensionally intersects a traveling road of a vehicle V;

FIG. 5 is a flowchart illustrating the driving support processing; and

FIG. 6 is a flowchart illustrating a method of setting an operating condition of collision reduction support.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

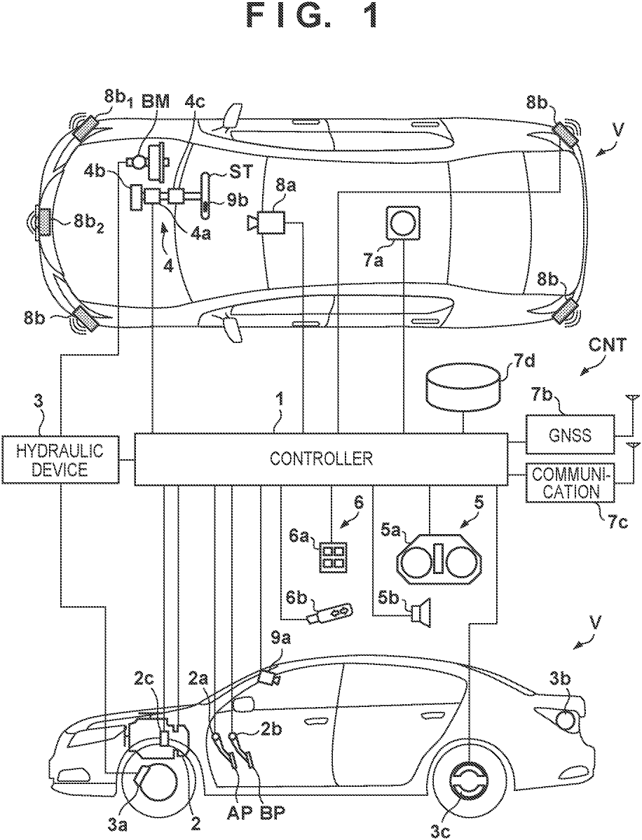

An embodiment according to the present invention will be described. FIG. 1 is a block diagram of a vehicle V and a control device CNT thereof according to the present embodiment. In FIG. 1, an outline of a vehicle V is illustrated by a plan view and a side view. The vehicle V of the present embodiment is, for example, a sedan-type four-wheel passenger vehicle, and may be, for example, a parallel hybrid vehicle. Note that the vehicle V is not limited to the four-wheeled passenger vehicle, and may be a straddle type vehicle (motorcycle or three-wheeled vehicle) or a large vehicle such as a truck or a bus.

### Configuration of Vehicle Control Device

The control device CNT includes a controller 1 that is an electronic circuit that executes control of the vehicle V including driving support of the vehicle V. The controller 1 includes a plurality of electronic control units (ECUs). The ECU is provided for each function of the control device CNT, for example. Each ECU includes a processor represented by a central processing unit (CPU), a storage device such as a semiconductor memory, an interface with an external device, and the like. The storage device stores a program executed by the processor, data used for processing by the processor, and the like. The interface includes an input/output interface and a communication interface. Each ECU may include a plurality of processors, a plurality of storage devices, and a plurality of interfaces.

The controller 1 controls driving (acceleration) of the vehicle V by controlling a power unit (power plant) 2. The power unit 2 is a travel driving unit that outputs driving force for rotating driving wheels of the vehicle V, and can include an internal combustion engine, a motor, and an automatic transmission. The motor can be used as a drive source for accelerating the vehicle V, and can also be used as a generator at the time of deceleration or the like (regenerative braking).

In the case of the present embodiment, the controller 1 controls the output of the internal combustion engine or the motor or switches a gear ratio of the automatic transmission in accordance with a driving operation of the driver or a vehicle speed detected by an operation detection sensor 2a provided on an accelerator pedal AP or an operation detection sensor 2b provided on a brake pedal BP. Note that the automatic transmission is provided with a rotation speed sensor 2c that detects a rotation speed of an output shaft of the automatic transmission as a sensor that detects a traveling state of the vehicle V. The vehicle speed of the vehicle V can be calculated from a detection result of the rotation speed sensor 2c.

The controller 1 controls braking (deceleration) of the vehicle V by controlling a hydraulic device 3. A braking operation of the driver on the brake pedal BP is converted into hydraulic pressure in a brake master cylinder BM and transmitted to the hydraulic device 3. The hydraulic device 3 is an actuator capable of controlling the hydraulic pressure of the hydraulic oil supplied to a brake device 3a (for example, a disc brake device) provided on each of the four wheels based on the hydraulic pressure transmitted from the brake master cylinder BM.

The controller 1 can control braking of the vehicle V by performing drive control of an electromagnetic valve or the like included in the hydraulic device 3. The controller 1 can also configure an electric servo brake system by controlling the distribution of a braking force by the brake device 3a and a braking force by regenerative braking of the motor included in the power unit 2. The controller 1 may turn on a brake lamp 3b at the time of braking.

The controller 1 controls steering of the vehicle V by controlling an electric power steering device 4. The electric power steering device 4 includes a mechanism that steers a front wheel according to the driving operation (steering operation) of the driver on a steering wheel ST. The electric power steering device 4 includes a drive unit 4a including a motor that exerts a driving force (sometimes referred to as a steering assist torque) for supporting steering operation or automatically steering the front wheel, a steering angle sensor 4b, a torque sensor 4c that detects steering torque (called steering load torque and distinguished from steering assist torque) borne by the driver, and the like.

The controller 1 controls an electric parking brake device 3c provided on a rear wheel. The electric parking brake device 3c includes a mechanism for locking the rear wheel. The controller 1 can control locking and unlocking of the rear wheel by the electric parking brake device 3c.

The controller 1 controls an information output device 5 that notifies information to the inside of the vehicle. The information output device 5 includes, for example, a display device 5a that notifies the driver of information by an image and/or a voice output device 5b that notifies the driver of information by a voice. The display device 5a can be provided on, for example, an instrument panel or a steering wheel ST. The display device 5a may be a head-up display. The information output device 5 may notify an occupant of information by vibration or light.

The controller 1 receives an instruction input from the occupant (for example, driver) via an input device 6. The input device 6 is disposed at a position operable by the driver, and includes, for example, a switch group 6a for the driver to instruct vehicle V and/or a direction indicator lever 6b for operating a direction indicator (direction indicator).

The controller 1 recognizes and determines a current position and a course (attitude) of the vehicle V. In the case of the present embodiment, the vehicle V is provided with a gyro sensor 7a, a global navigation satellite system (GNSS) sensor 7b, and a communication device 7c. The gyro sensor 7a detects rotational motion (yaw rate) of the vehicle V. The GNSS sensor 7b detects the current position of the vehicle V. In addition, the communication device 7c performs wireless communication with a server that provides map information and traffic information, and acquires these pieces of information. In the case of the present embodiment, the controller 1 determines the course of the vehicle V based on the detection results of the gyro sensor 7a and the GNSS sensor 7b, sequentially acquires highly accurate map (high-definition map) information regarding the course from the server via the communication device 7c, and stores the map information in a database 7d (storage device). Note that the vehicle V may be provided with a sensor for detecting the state of the vehicle V, such as a speed sensor for detecting the speed of the vehicle V or an acceleration sensor for detecting the acceleration of the vehicle V.

The controller 1 executes driving support of the vehicle V based on detection results of various detection units provided in the vehicle V. The vehicle V is provided with surroundings detection units 8a and 8b, which are external sensors that detect the outside (surrounding situation) of the vehicle V, and in-vehicle detection units 9a and 9b, which are in-vehicle sensors that detect the situation inside the vehicle (the state of the driver). The controller 1 can grasp the surrounding situation of the vehicle V based on the detection results of the surroundings detection units 8a and 8b, and execute the driving support according to the surrounding situation. In addition, the controller 1 can determine whether the driver is fulfilling a predetermined operation obligation imposed on the driver when executing the driving support based on the detection results of the in-vehicle detection units 9a and 9b.

The surroundings detection unit 8a is an imaging device (hereinafter, may be referred to as a front camera 8a) that captures an image of the front of the vehicle V, and is attached to a vehicle interior side of a windshield at the front of a roof of the vehicle V, for example. The controller 1 can extract a contour of a target or a lane division line (such as a white line) on a road by analyzing an image captured by the front camera 8a.

The surroundings detection unit 8b is a millimeter wave radar (hereinafter, may be referred to as a radar 8b), detects a target around the vehicle V using radio waves, and detects (measures) a distance to the target and a direction (azimuth) of the target with respect to the vehicle V. In the example illustrated in FIG. 1, five radars 8b are provided, one at the center of the front portion of the vehicle V, one at each of the left and right corner portions of the front portion, and one at each of the left and right corner portions of the rear portion.

Note that the surroundings detection unit provided in the vehicle V is not limited to the above configuration, and the number of cameras and the number of radars may be changed, or a light detection and ranging (LiDAR) for detecting a target around the vehicle V may be provided.

The in-vehicle detection unit 9a is an imaging device (hereinafter, may be referred to as an in-vehicle camera 9a) that captures an image of the inside of the vehicle, and is attached to, for example, the vehicle interior side at the front of the roof of the vehicle V. In the case of the present embodiment, the in-vehicle camera 9a is a driver monitor camera that captures an image of a driver (for example, eyes and a face of the driver). The controller 1 can determine the direction of the line of sight and the face of the driver by analyzing an image (a face image of the driver) captured by the in-vehicle camera 9a.

The in-vehicle detection unit 9b is a grip sensor (hereinafter, may be referred to as a grip sensor 9b) that detects grip of the steering wheel ST by the driver, and is provided in at least a part of the steering wheel ST, for example. As the in-vehicle detection unit, the torque sensor 4c that detects the steering torque of the driver may be used.

Examples of the driving support of the vehicle V include acceleration/deceleration support, lane keeping support, and lane change support. The acceleration/deceleration support is driving support (adaptive cruise control (ACC)) that controls acceleration/deceleration of the vehicle V within a predetermined vehicle speed while maintaining an inter-vehicle distance from a preceding vehicle by controlling the power unit 2 and the hydraulic device 3. The lane keeping support is driving support (lane keeping assist system (LKAS)) that controls the electric power steering device 4 to keep the vehicle V inside the lane. The lane change support is driving support (ALC: Auto Lane Changing, ALCA: Active Lane Change Assist) for changing a traveling lane of the vehicle V to the adjacent lane by controlling the electric power steering device 4. In addition, the driving support executed by the controller 1 may include a collision reduction brake, an ABS function, traction control, and/or attitude control of the vehicle V for supporting collision avoidance with a target (for example, a pedestrian, another vehicle, or an obstacle) on the road by controlling the hydraulic device 3.

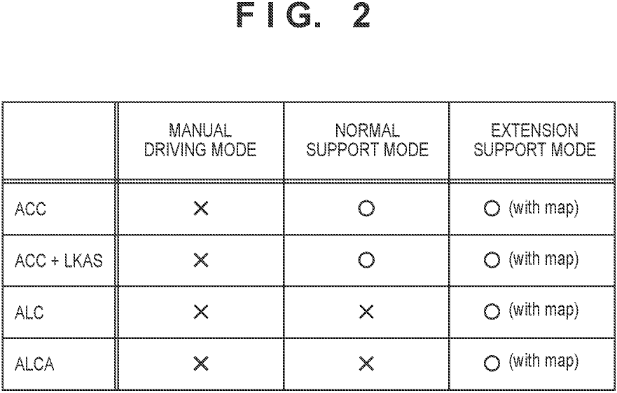

The driving support (acceleration/deceleration support, lane keeping support, lane change support) of the vehicle V is executed in a plurality of driving modes including a manual driving mode, a normal support mode, and an extension support mode. FIG. 2 illustrates driving support executed in each of the manual driving mode, the normal support mode, and the extension support mode of the present embodiment. In the manual driving mode, acceleration/deceleration support, lane keeping support, and lane change support are not executed, and manual driving of the vehicle V is performed by the driver.

In the manual driving mode, when an instruction to set the acceleration/deceleration support (ACC) is input by the driver via the input device 6 (for example, the switch group 6a), the acceleration/deceleration support is started, and the mode is shifted from the manual driving mode to the normal support mode. In the normal support mode, the lane keeping support (LKAS) can be executed in addition to the acceleration/deceleration support. The lane keeping support is started when an instruction input for setting the lane keeping support is made by the driver via the input device 6 (for example, the switch group 6a) during the setting of the acceleration/deceleration support. The acceleration/deceleration support and the lane keeping support are terminated when an instruction to cancel the setting is input by the driver via the input device 6 (for example, the switch group 6a).

In the normal support mode, the driver is required to fulfill predetermined operation obligation such as periphery monitoring and steering wheel gripping. When it is determined that the driver does not fulfill the predetermined operation obligation based on the detection result of the in-vehicle detection unit 9b, a notification for prompting the driver to fulfill the predetermined operation obligation is fulfilled via the information output device 5.

When traveling on a specific road is started during execution of the normal support mode, highly accurate map information is acquired by the communication device 7c. Then, when matching between the highly accurate map information and the image captured by the front camera 8a is successful, the normal support mode is automatically shifted to the extension support mode. The specific road is a road that provides highly accurate map information, and examples thereof include an expressway and an automobile exclusive road. The highly accurate map information includes, in addition to normal information such as a route and a position of a specific road, information related to a detailed shape of the specific road such as presence or absence of a curve, a curvature, an increase or decrease of a lane, and a gradient in the specific road. When the mode shifts from the normal support mode to the extension support mode, the information output device 5 notifies that the mode has shifted to the extension support mode, for example, by changing the light emission color of the display device 5a provided on the steering wheel ST.

In the extension support mode, the acceleration/deceleration support (and lane keeping support) in cooperation with highly accurate map information is performed. For example, based on highly accurate map information, the controller 1 can perform acceleration/deceleration support more advanced than the normal support mode, such as decelerating the vehicle V before a curve or before a point where a lane decreases, or adjusting the speed of the vehicle V according to the curvature of the curve. Similarly to the normal support mode, the extension support mode also imposes a predetermined operation obligation on the driver, such as periphery monitoring and steering wheel gripping. When it is determined that the driver does not fulfill the predetermined operation obligation based on the detection result of the in-vehicle detection unit 9b, a notification for prompting the driver to fulfill the predetermined operation obligation is fulfilled via the information output device 5.

In addition, in the extension support mode, lane change support can be further executed. In the case of the present embodiment, the lane change support includes system-initiated lane change support (Auto Lane Changing (ALC)) that automatically changes the lane based on the determination of the controller 1, and driver-initiated lane change support (Active Lane Change Assist (ALCA)) that automatically changes the lane based on an instruction input from the driver. Note that, in both the system-initiated lane change support (ALC) and the driver-initiated lane change support (ALCA), when performing the lane change support, the driver is required to fulfill predetermined operation obligations such as periphery monitoring and steering wheel gripping.

The system-initiated lane change support (ALC) is started when an instruction input for setting the ALC in the extension support mode is performed by the driver via the input device 6 (for example, the switch group 6a). During the ALC setting, the controller 1 sequentially determines whether it is necessary to execute a lane change in order to arrive at a destination set in advance by the driver based on highly accurate map information (information such as increase/decrease or branching of a lane), and automatically performs the lane change when determining that it is necessary to execute the lane change. During the ALC setting, one or more lane changes can be executed according to the determination of the controller 1. The ALC ends when the vehicle arrives at the destination or when the specific road ends. The ALC may be ended in a case where an instruction input to cancel the setting is performed by the driver via the input device 6 (for example, the switch group 6a).

The driver-initiated lane change support (ALCA) is to perform one lane change in response to an instruction input by the driver, and is executed when the instruction input for instructing execution of ALCA in the extension support mode is performed by the driver via the input device 6 (for example, the direction indicator lever 6b). In the ALCA, the driver can perform an instruction input of a direction for requesting a lane change via the input device 6 (direction indicator lever 6b), and the controller 1 automatically performs a lane change to an adjacent lane in the direction in which the instruction is input by the driver. In the present embodiment, the ALCA can be executed based on highly accurate map information, but is not limited thereto, and may be executed without using highly accurate map information. The ALCA can also be executed during the setting of the system-initiated lane change support (ALC).

### Configuration of Driving Support Device

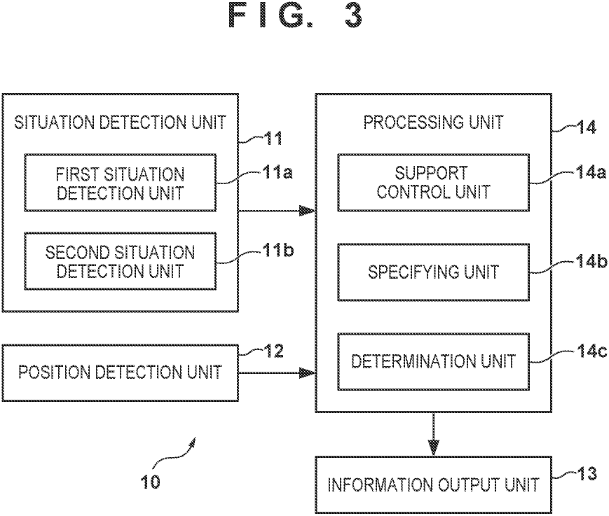

Hereinafter, a configuration example of the driving support device 10 of the present embodiment will be described with reference to FIG. 3. FIG. 3 is a block diagram illustrating a configuration example of the driving support device 10 of the present embodiment, and is obtained by extracting a configuration and a function particularly related to the present invention from the control device CNT described above. The driving support device 10 of the present embodiment is a device that performs collision reduction support as driving support of the vehicle V, and can include, for example, a situation detection unit 11 (situation detector), a position detection unit 12 (position detector), an information output unit 13, and a processing unit 14 (processor). The situation detection unit 11, the position detection unit 12, the information output unit 13, and the processing unit 14 are communicably connected to each other via a system bus.

The situation detection unit 11 is a radar 8b provided at the front of the vehicle V so as to detect a target (for example, an obstacle, another vehicle, or a pedestrian) in front of the vehicle V in the surroundings detection unit (front camera 8a, radar 8b) illustrated in FIG. 1, and includes a first situation detection unit 11a (first detector) and a second situation detection unit 11b (second detector). The first situation detection unit 11a is constituted by a sensor having no resolution in an up-down direction (height direction) of the vehicle V, and is, for example, a radar 8b₁ provided at a front corner portion of vehicle V as illustrated in FIG. 1. In addition, the second situation detection unit 11b is constituted by a sensor having resolution in the vertical direction (height direction) of the vehicle V, and is, for example, a radar 8b₂ provided in a front central portion of the vehicle V as illustrated in FIG. 1.

The position detection unit 12 is, for example, a GNSS sensor 7b illustrated in FIG. 1, and detects a current position and a traveling direction of vehicle V. The position detection unit 12 may include a gyro sensor 7a in addition to the GNSS sensor 7b. The information output unit 13 is, for example, the information output device 5 illustrated in FIG. 1, and notifies an occupant (for example, a driver) of the vehicle V of various types of information using the display device 5a and/or the voice output device 5b. In the case of the present embodiment, the information output unit 13 can be used to warn (notify) the driver that the possibility of collision with a target (obstacle, other vehicles) in the traveling direction has increased.

The processing unit 14 is constituted by a computer including a processor represented by a central processing unit (CPU), a storage device such as a semiconductor memory, an interface with an external device, and the like, and can function as a part of the controller 1 (ECU) illustrated in FIG. 1. The storage device stores a program (driving support program) for providing driving support to the driver of the vehicle V, and the processing unit 14 can read and execute the driving support program stored in the storage device. The processing unit 14 of the present embodiment can be provided with a support control unit 14a, a specifying unit 14b, and a determination unit 14c.

The support control unit 14a operates driving support for the vehicle V when a positional relationship between the target and the vehicle V detected by the situation detection unit 11 (first situation detection unit 11a and/or second situation detection unit 11b) satisfies the operating condition. For example, the support control unit 14a calculates an index indicating the positional relationship between the target detected by the situation detection unit 11 and the vehicle V, and operates the driving support when an operating condition that the index has reached a threshold value is satisfied. The support control unit 14a of the present embodiment controls the collision reduction support as the driving support. The collision reduction support includes a collision warning and/or a collision reduction brake. The collision warning notifies the driver that the possibility of collision with the target detected by situation detection unit 11 has increased (deceleration of vehicle V is necessary). The collision reduction brake controls the hydraulic device 3 (brake device 3a) to support deceleration of the vehicle V when the possibility of collision with a target detected by the situation detection unit 11 increases. Further, as the index indicating the positional relationship between the target detected by the situation detection unit 11 and the vehicle V, a time-to-collision (TTC) may be applied. In this case, the support control unit 14a operates the collision reduction support (collision warning and/or collision reduction brake) as the driving support when the time-to-collision reaches the threshold value, that is, when the time-to-collision becomes less than or equal to the threshold value. The collision reduction support is driving support that can be set in all of the plurality of driving modes (for example, the manual mode, the normal support mode, and the extension support mode) described above.

The specifying unit 14b specifies the traveling road and the traveling course of the vehicle V by executing known map matching processing based on the detection result (the current position and the traveling direction of the vehicle V) of the position detection unit 12 and the map information. That is, the specifying unit 14b performs map matching of the current position and the traveling direction of the vehicle V detected by the position detection unit 12 with respect to the map information, thereby specifying a road (traveling road) on which the vehicle V is traveling and a course (traveling course) on which the vehicle V will travel from now. Note that the map information used by the specifying unit 14b may be highly accurate map information provided on a specific road as described above, but is not limited to the highly accurate map information. In addition, the map information used by the specifying unit 14b may be map information acquired by the communication device 7c, or may be map information stored (already) in the database 7d in advance. The same applies to map information used by the determination unit 14c described later.

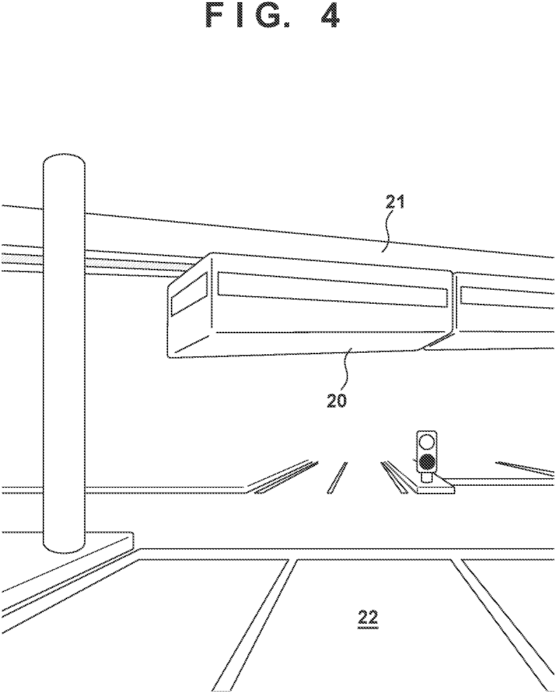

The determination unit 14c determines whether there is an intersecting structure that three-dimensionally intersects the traveling road of the vehicle V in the traveling course of the vehicle V specified by the specifying unit 14b. For example, the determination unit 14c determines whether there is an intersecting structure in the traveling course of the vehicle V based on the traveling course of the vehicle V specified by the specifying unit 14b and the map information (map information of an area including the traveling course of the vehicle V). The intersecting structure is an overhead structure that crosses the sky above the traveling road of the vehicle V, for example, an overpass (over-bridge, pedestrian bridge) and/or a railway (for example, a monorail). FIG. 4 illustrates a view seen from a windshield of the vehicle V to describe the intersecting structure, and illustrates an example in which a railroad 21 of a monorail 20 as the intersecting structure three-dimensionally intersects a traveling road 22 of the vehicle V.

Here, depending on the shape (gradient or the like) of the traveling road for passing under the intersecting structure, situation detection unit 11 may detect the intersecting structure as a target. Although the possibility that the vehicle V will collide with such an intersecting structure is very low, the support control unit 14a may operates the collision reduction support (collision warning and/or collision reduction brake) when the intersecting structure is detected by the situation detection unit 11 and the positional relationship between the intersecting structure and the vehicle V satisfies the operating condition. That is, the support control unit 14a may operate the collision reduction support even for a target which is not originally an object to be operated by the collision reduction support. In particular, since the first situation detection unit 11a has no resolution in the height direction, when the first situation detection unit 11a detects the intersecting structure as a target, the support control unit 14a operates the collision reduction support with respect to the intersecting structure.

Therefore, the driving support device 10 according to the present embodiment is provided with the determination unit 14c that determines whether there is an intersecting structure on the traveling course of the vehicle V specified by the specifying unit 14b. When the determination unit 14c determines that there is an intersecting structure on the traveling course of the vehicle V, the support control unit 14a changes the operating condition so that the operation of the driving support (collision reduction support) for the target detected by the first situation detection unit 11a is restricted. Specifically, when the determination unit 14c determines that there is the intersecting structure on the traveling course of the vehicle V, the support control unit 14a changes the operating condition of the collision reduction support with respect to the target detected by the first situation detection unit 11a such that the operation of the collision reduction support is restricted as compared with the case where the determination unit 14c determines that there is no intersecting structure on the traveling course of the vehicle V. As a result, even when the first situation detection unit 11a detects the intersecting structure, it is possible to reduce malfunction of the collision reduction support with respect to the intersecting structure. It should be noted that the description “restricting the operation of the collision reduction support” used in the present embodiment may be understood as “making it difficult to operate the collision reduction support”, but is performed within a range in which safety such as collision avoidance is compensated.

### Driving Support Processing]

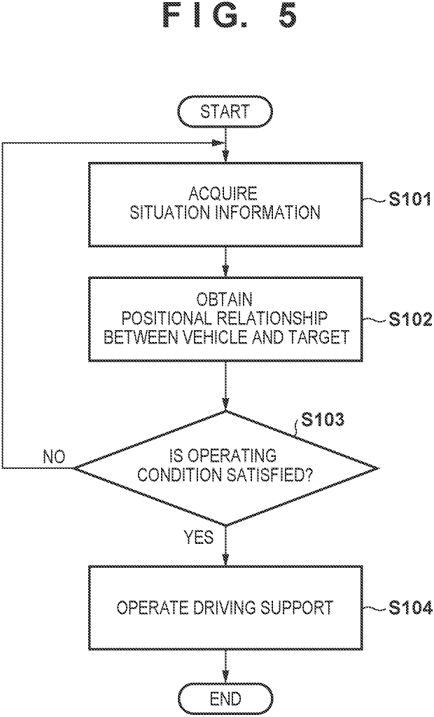

Hereinafter, the driving support processing of the present embodiment will be described. FIG. 5 is a flowchart illustrating the driving support processing according to the present embodiment. The flowchart of FIG. 5 is a flowchart for performing the collision reduction support as the driving support, and can be performed by the processing unit 14 (support control unit 14a) when the driving support program is executed in the driving support device 10.

In Step S101, the processing unit 14 acquires, from the situation detection unit 11, information (situation information) indicating the surrounding situation of the vehicle V detected by situation detection unit 11 (first situation detection unit 11a and/or second situation detection unit 11b). Next, in Step S102, the processing unit 14 specifies a target included in the situation information acquired in Step S101, and obtains a positional relationship between the vehicle V and the target. In the present embodiment, the processing unit 14 obtains the time-to-collision (TTC) as an index indicating the positional relationship between a target detected by the situation detection unit 11 and the vehicle V.

In Step S103, the processing unit 14 determines whether the positional relationship between the vehicle V and the target obtained in Step S102 satisfies an operating condition that is a condition for operating the driving support (collision reduction support). For example, the processing unit 14 determines whether the operating condition that the time-to-collision obtained as an index indicating the positional relationship between the vehicle V and the target has reached the threshold is satisfied. When the operating condition is not satisfied, the process returns to Step S101. Meanwhile, when the operating condition is satisfied, the process proceeds to Step S104, and the processing unit 14 operates the driving support (collision reduction support) of the vehicle V. In the present embodiment, a collision warning and/or a collision reduction brake are applied as the collision reduction support.

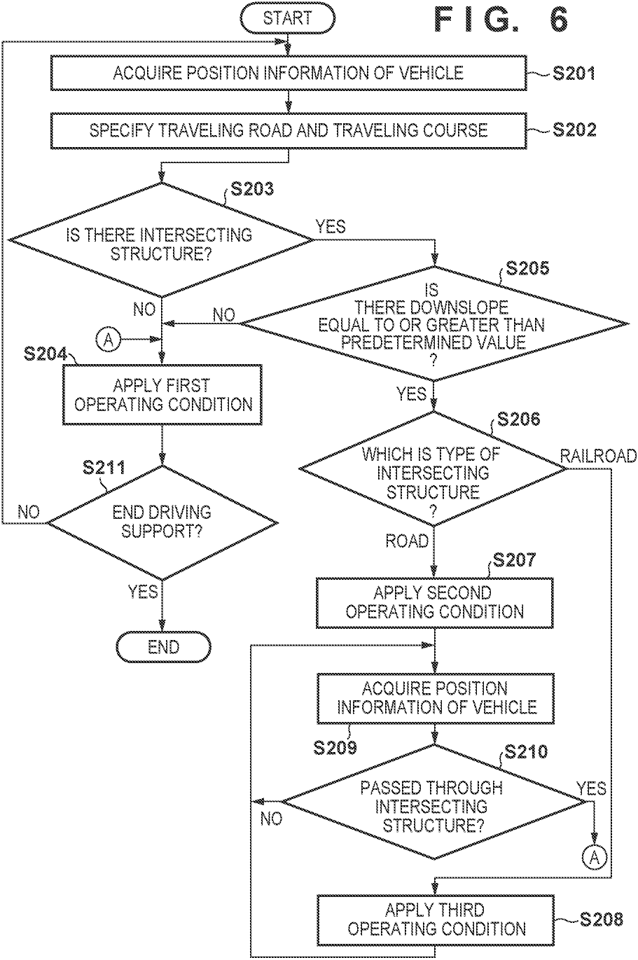

Next, the setting (change) of the operating condition of the collision reduction support used in the driving support processing of FIG. 5 will be described. FIG. 6 is a flowchart illustrating a method of setting an operating condition of the collision reduction support. The flowchart of FIG. 6 can be executed by the processing unit 14 when the driving support program is executed in the driving support device 10. The flowchart of FIG. 6 can be implemented in parallel and independently of the flowchart of FIG. 5. Here, it is preferable that the setting (change) of the operating condition of the collision reduction support according to the flowchart of FIG. 6 is performed only for the first situation detection unit 11a (radar 8b₁) having no resolution in the height direction, and is not performed for the second situation detection unit 11b having the resolution in the height direction even when the determination unit 14c determines that there is the intersecting structure on the traveling course of the vehicle V, in terms of reducing the processing load of the processing unit 14. However, the present invention is not limited thereto, and the setting (change) of the operating condition of the collision reduction support according to the flowchart of FIG. 6 may be performed on the second situation detection unit 11b.

In Step S201, the processing unit 14 (specifying unit 14b) acquires information (hereinafter, it may be referred to as position information) indicating the current position and the traveling direction of vehicle V detected by the position detection unit 12. Next, in Step S202, the processing unit 14 (specifying unit 14b) specifies the traveling road and the traveling course of the vehicle V by executing known map matching processing based on the position information and the map information acquired in Step S201. Hereinafter, the information indicating the traveling road and the traveling course of vehicle V specified in Step S202 may be referred to as “traveling information”.

In Step S203, the processing unit 14 (determination unit 14c) determines whether there is the intersecting structure that three-dimensionally intersects the traveling road of the vehicle V in the traveling course of the vehicle V based on the traveling information and the map information obtained in Step S202. When it is determined that there is no intersecting structure on the traveling course of the vehicle V, the process proceeds to Step S204, and the processing unit 14 sets the operating condition of the collision reduction support of the vehicle V to the first operating condition. For example, when the threshold of the time-to-collision is applied as the operating condition, the threshold as the first operating condition can be set to 2 seconds. Meanwhile, when it is determined that there is an intersecting structure on the traveling course of the vehicle V, the process proceeds to Step S205. Here, the first operating condition is an operating condition applied as an initial setting when the collision reduction support is started, for example, when the ignition of the vehicle V is turned on, or when the setting of the collision reduction support is turned on by the driver via the input device 6 (switch group 6a). That is, in a case where the first operating condition has been set so far, the first operating condition is maintained as it is in Step S204.

In Step S205, the processing unit 14 (determination unit 14c) determines whether there is a gradient (upslope, downslope) of a predetermined value or more between the vehicle V and the intersecting structure in the traveling course of the vehicle V based on the traveling information obtained in Step S202 and the map information stored in the database 7d. The predetermined value can be set in advance to a value (angle) at which there is a possibility that the radio wave emitted from the first situation detection unit 11a will be directed to the intersecting structure while the vehicle V travels on the gradient by an experiment, a simulation, or the like. As an example, the predetermined value may be set to, for example, 5 degrees (gradient 9%). The upper limit value of the gradient can be set to 30 degrees or less (gradient 58% or less). When it is determined that there is no gradient equal to or greater than the predetermined value between the vehicle V and the intersecting structure on the traveling course of the vehicle V, the process proceeds to Step S204, and when it is determined that there is a gradient equal to or greater than the predetermined value, the process proceeds to Step S206.

Here, when there is no gradient equal to or greater than the predetermined value between the vehicle V and the intersecting structure in the traveling course of the vehicle V, there is a low possibility that the intersecting structure will be detected by the first situation detection unit 11a (radar 8b₁). Meanwhile, when there is the gradient, the radio wave emitted from the first situation detection unit 11a is directed to the intersecting structure, and there is a high possibility that the intersecting structure will be detected by the first situation detection unit 11a. Therefore, in the present embodiment, this Step S205 is provided so that relaxation (change to the second operating condition or the third operating condition) of the operating condition of the collision reduction support to be described later is performed only in a situation where there is a relatively high possibility that the first situation detection unit 11a will detect the intersecting structure. In other words, this Step S205 is provided so that the relaxation of the operating condition of the collision reduction support is not performed in a situation where the possibility that the intersecting structure will be detected by the first situation detection unit 11a is relatively low. Note that this Step S205 may not be provided when the operating condition of the collision reduction support is relaxed without being limited to the presence or absence of the gradient.

In Step S206, the processing unit 14 (determination unit 14c) identifies (determines) the type of the intersecting structure based on the map information. In the case of the present embodiment, the processing unit 14 identifies, as the type of the intersecting structure, whether the intersecting structure is a road through which automobiles and/or pedestrians pass or a railroad on which a train passes. When the intersecting structure is identified as a road, the process proceeds to Step S207, and the processing unit 14 sets the operating condition of the collision reduction support of the vehicle V as the second operating condition. This Step S207 may be understood as a step of changing the operating condition of the collision reduction support of the vehicle V from the first operating condition to the second operating condition. The second operating condition is set such that the operation of the collision reduction support is limited more than the first operating condition. For example, in a case where the threshold value of the time-to-collision is applied as the operating condition, the threshold value as the second operating condition may be set to 1.5 seconds in which the operation of the collision reduction support is limited compared to the first operating condition.

Meanwhile, when the intersecting structure is identified as a railroad in Step S206, the process proceeds to Step S208, and the processing unit 14 sets the operating condition of the collision reduction support of the vehicle V as the third operating condition. This Step S208 may be understood as a step of changing the operating condition of the collision reduction support of the vehicle V from the first operating condition to the third operating condition. The third operating condition is set such that the operation of the collision reduction support is limited by the first operating condition and the second operating condition. For example, when the threshold of the time-to-collision is applied as the operating condition, the threshold as the third operating condition may be set to 1.2 seconds in which the operation of the collision reduction support is limited compared to the first operating condition and the second operating condition.

By changing the operating condition according to the type of the intersecting structure in this manner, the operation of the collision reduction support can be restricted according to the ease (that is, it is easy to reflect the radio wave in the intersecting structure) of detection of the intersecting structure by the first situation detection unit 11a. For example, as illustrated in FIG. 4, when the railroad 21 of a suspension-type monorail 20 three-dimensionally intersects the traveling road 22 of the vehicle V as the intersecting structure, the monorail 20 and the railroad 21 have a structure that easily reflects the radio wave emitted from the first situation detection unit 11a as compared with the road on which the automobile and/or the pedestrian pass, and are easily detected by the first situation detection unit 11a. That is, the collision reduction support is more likely to malfunction when the intersecting structure is the railroad than when the intersecting structure is the road. Therefore, in the present embodiment, the malfunction of the collision reduction support is reduced by setting the operating condition (second operating condition and third operating condition) such that the operation of the collision reduction support is limited in the case where the intersecting structure is the railroad rather than the case where the intersecting structure is the road.

In Step S209, the processing unit 14 (specifying unit 14b) acquires the position information of the vehicle V detected by the position detection unit 12. Next, in Step S210, the processing unit (determination unit 14c) determines whether the vehicle V has passed through the intersecting structure. When the vehicle V has not passed through the intersecting structure, Steps S209 and S210 are repeatedly executed. Meanwhile, when the vehicle V has passed through the intersecting structure, the process proceeds to Step S204, and the processing unit 14 sets the operating condition of the collision reduction support of the vehicle V as the first operating condition. Step S204 in this case may be understood as a step of restoring the operating condition of the collision reduction support of the vehicle V, that is, a step of changing the operating condition of the collision reduction support of the vehicle V from the second operating condition or the third operating condition to the original first operating condition.

In Step S211, the processing unit 14 determines whether to end the collision reduction support for the vehicle V. For example, the processing unit 14 can determine to end the collision reduction support for the vehicle V when the setting of the collision reduction support is turned off by the driver or when the ignition of the vehicle V is turned off. In a case where the collision reduction support of the vehicle V is not ended, the process returns to Step S201.

As described above, the driving support device 10 of the present embodiment determines whether there is the intersecting structure in the traveling course of the vehicle V, and when it is determined that there is the intersecting structure in the traveling course of the vehicle V, the operating condition is changed so that the operation of the driving support (collision reduction support) with respect to the target detected by the first situation detection unit 11a is restricted. As a result, even when the first situation detection unit 11a detects the intersecting structure, it is possible to reduce malfunction of the collision reduction support with respect to the intersecting structure.

### <Other Embodiments>

The driving support program described in the above embodiment is supplied to the driving support device 10 via a network or a storage medium, and a computer (for example, one or more processors constituting the processing unit 14) of the driving support device 10 can read and execute the program. The present invention can also be realized by such an aspect.

### <Summary of Embodiments >

1. A driving support device of the above-described embodiment is a driving support device (e.g. 10) that performs driving support of a vehicle (e.g. V), the driving support device comprising:
a detector (e.g. 8b₁, 11a) configured to detect a surrounding situation of the vehicle;
a control unit (e.g. 14a) configured to operate the driving support of the vehicle in a case where a positional relationship between a target detected by the detector and the vehicle satisfies an operating condition;
a specifying unit (e.g. 14b) configured to specify a traveling course of the vehicle; and
a determination unit (e.g. 14c) configured to determine whether there is an intersecting structure that three-dimensionally intersects a traveling road of the vehicle in the traveling course specified by the specifying unit,
wherein in a case where the determination unit determines that there is the intersecting structure in the traveling course, the control unit changes the operating condition such that operation of the driving support with respect to the target detected by the detector is restricted.

According to this configuration, even when the intersecting structure is detected by the detection unit, it is possible to reduce malfunction of driving support with respect to the intersecting structure.

2. In the above-described embodiment,

the determination unit determines whether there is the intersecting structure in the traveling course based on map information of an area including the traveling course specified by the specifying unit.

According to this configuration, it is possible to accurately determine whether there is an intersecting structure on the traveling course of the vehicle.

3. In the above-described embodiment,
the determination unit determines whether there is a gradient equal to or greater than a predetermined value between the vehicle and the intersecting structure in the traveling course specified by the specifying unit, and
in a case where the determination unit further determines that there is the gradient equal to or greater than the predetermined value, the control unit changes the operating condition such that the operation of the driving support with respect to the target is restricted.

According to this configuration, only when there is the gradient equal to or greater than the predetermined value between the vehicle and the intersecting structure on the traveling course of the vehicle and there is a relatively high possibility that the intersecting structure will be detected by the detection unit, the operating condition of the driving support can be relaxed.

4. In the above-described embodiment,
the determination unit identifies a type of the intersecting structure in the traveling course specified by the specifying unit, and
the control unit changes the operating condition according to the type of the intersecting structure identified by the determination unit.

According to this configuration, the operation of the driving support can be appropriately limited according to the ease (that is, it is easy to reflect the radio wave in the intersecting structure) of detection of the intersecting structure by the detection unit.

5. In the above-described embodiment,
the determination unit identifies whether the intersecting structure is a road or a railroad as the type of the intersecting structure, and
the control unit changes the operating condition such that the operation of the driving support is restricted in a case where the type of the intersecting structure is a railroad rather than in a case where the type of the intersecting structure is a road.

According to this configuration, the detection by the detection unit is easier in a case where the intersecting structure is a railroad than in a case where the intersecting structure is a road. Therefore, operation of driving support can be appropriately limited accordingly.

6. In the above-described embodiment,

the control unit restores the operating condition in a case where the vehicle passes through the intersecting structure.

According to this configuration, the driving support can be appropriately operated after the vehicle passes through the intersecting structure.

7. In the above-described embodiment,
the operating condition includes that an index indicating the positional relationship has reached a threshold, and
in a case where the determination unit determines that the target detected by the detector is the intersecting structure, the control unit changes the threshold such that operation of the driving support with respect to the target is restricted.

According to this configuration, it is possible to appropriately operate the driving support based on the index indicating the positional relationship between the target and the vehicle detected by the detection unit.

8. In the above-described embodiment,

the driving support includes deceleration support of the vehicle and/or a notification that deceleration of the vehicle is necessary.

According to this configuration, the collision reduction support as the driving support can be appropriately operated.

9. In the above-described embodiment,

the detector includes a sensor (e.g. 8b₁) having no resolution in a height direction.

According to this configuration, even when the intersecting structure is detected by the sensor having no resolution in the height direction, the driving support can be appropriately operated. In addition, since a sensor having no resolution in the height direction can be provided in the vehicle, it is also advantageous in terms of vehicle cost.

10. In the above-described embodiment,

the detector is provided at a front corner portion of the vehicle.

According to this configuration, even when the intersecting structure is detected by the sensor provided at the front corner portion of the vehicle and having no resolution in the height direction, the driving support can be appropriately operated.

11. In the above-described embodiment,
the driving support device further comprises a second detector (e.g. 11b) configured by a sensor (e.g. 8b₂) having resolution in the height direction and configured to detect a surrounding situation of the vehicle, wherein
the control unit operates the driving support in a case where the positional relationship between the target detected by the second detector and the vehicle satisfies the operating condition, and
the control unit does not change the operating condition for the second detector even when the determination unit determines that there is the intersecting structure in the traveling course.

According to this configuration, a processing load for changing the operating condition of the driving support can be reduced.

12. In the above-described embodiment,

the second detector is provided in a front central portion of the vehicle.

According to this configuration, the driving support can be appropriately performed using the sensor provided in the front central portion of the vehicle.

The invention is not limited to the foregoing embodiments, and various variations/changes are possible within the spirit of the invention.

What is claimed is:

1. A driving support device that performs driving support of a vehicle, the driving support device comprising:
a detector configured to detect a surrounding situation of the vehicle;
a control unit configured to operate the driving support of the vehicle in a case where a positional relationship between a target detected by the detector and the vehicle satisfies an operating condition;
a specifying unit configured to specify a traveling course of the vehicle; and
a determination unit configured to determine whether there is an intersecting structure that three-dimensionally intersects a traveling road of the vehicle in the traveling course specified by the specifying unit,
wherein in a case where the determination unit determines that there is the intersecting structure in the traveling course, the control unit changes the operating condition such that operation of the driving support with respect to the target detected by the detector is restricted.

2. The driving support device according to claim 1, wherein the determination unit determines whether there is the intersecting structure in the traveling course based on map information of an area including the traveling course specified by the specifying unit.

3. The driving support device according to claim 1, wherein
the determination unit determines whether there is a gradient equal to or greater than a predetermined value between the vehicle and the intersecting structure in the traveling course specified by the specifying unit, and
in a case where the determination unit further determines that there is the gradient equal to or greater than the predetermined value, the control unit changes the operating condition such that the operation of the driving support with respect to the target is restricted.

4. The driving support device according to claim 1, wherein
the determination unit identifies a type of the intersecting structure in the traveling course specified by the specifying unit, and
the control unit changes the operating condition according to the type of the intersecting structure identified by the determination unit.

5. The driving support device according to claim 4, wherein
the determination unit identifies whether the intersecting structure is a road or a railroad as the type of the intersecting structure, and
the control unit changes the operating condition such that the operation of the driving support is restricted in a case where the type of the intersecting structure is a railroad rather than in a case where the type of the intersecting structure is a road.

6. The driving support device according to claim 1, wherein the control unit restores the operating condition in a case where the vehicle passes through the intersecting structure.

7. The driving support device according to claim 1, wherein
the operating condition includes that an index indicating the positional relationship has reached a threshold, and
in a case where the determination unit determines that the target detected by the detector is the intersecting structure, the control unit changes the threshold such that operation of the driving support with respect to the target is restricted.

8. The driving support device according to claim 1, wherein the driving support includes deceleration support of the vehicle and/or a notification that deceleration of the vehicle is necessary.

9. The driving support device according to claim 1, wherein the detector includes a sensor having no resolution in a height direction.

10. The driving support device according to claim 9, wherein the detector is provided at a front corner portion of the vehicle.

11. The driving support device according to claim 9, further comprising a second detector configured by a sensor having resolution in the height direction and configured to detect a surrounding situation of the vehicle, wherein
the control unit operates the driving support in a case where the positional relationship between the target detected by the second detector and the vehicle satisfies the operating condition, and
the control unit does not change the operating condition for the second detector even when the determination unit determines that there is the intersecting structure in the traveling course.

12. The driving support device according to claim 11, wherein the second detector is provided in a front central portion of the vehicle.

13. A vehicle comprising the driving support device according to claim 1.

14. A driving support method for performing driving support of a vehicle, the method comprising:
detecting a surrounding situation of the vehicle; and
operating the driving support of the vehicle in a case where a positional relationship between a detected target and the vehicle satisfies an operating condition,
wherein the operating the driving support includes
determining whether there is an intersecting structure that three-dimensionally intersects a traveling road of the vehicle in a traveling course of the vehicle, and
changing, in a case of determining that there is the intersecting structure in the traveling course, the operating condition such that operation of the driving support with respect to the detected target is restricted.

15. A non-transitory computer-readable storage medium storing a program for causing a computer to execute a driving support method according to claim 14.
